(19) United States
(12) Patent Application Publication
(10) Pub. No.: US 2013/0338264 A1
(43) Pub. Date: Dec. 19, 2013

(54) CONDENSATION PRODUCTS OF MELAMINE AND PHENYLPHOSPHONIC ACID AND THEIR USE AS FLAME RETARDANTS

(71) Applicants: Thomas Weiss, Ilvesheim (DE); Beat Michael Aebli, Basel (CH); Rainer Xalter, Basel (CH)

(72) Inventors: Thomas Weiss, Ilvesheim (DE); Beat Michael Aebli, Basel (CH); Rainer Xalter, Basel (CH)

(73) Assignee: BASF SE, Ludwigshafen (DE)

(21) Appl. No.: 14/002,146

(22) PCT Filed: Mar. 9, 2012
(86) PCT No.: PCT/IB12/51113

§ 371 Date: Aug. 29, 2013

Related U.S. Application Data
(60) Provisional application No. 61/451,634, filed on Mar. 11, 2011.

(30) Foreign Application Priority Data
Mar. 11, 2011 (EP) 11157932.2

(51) Int. Cl. C08K 5/5317

(52) U.S. Cl. CPC C08K 5/5317
USPC 523/451; 544/195; 524/100

(57) ABSTRACT

Condensation products of melamine and phenylphosphonic acid, a process for their preparation, their compositions with polymeric materials and their use as flame retardants in polymer substrates are provided. The compositions are especially useful for the manufacture of flame retardant compounds based on polyfunctional epoxides or polycondensates, such as polyesters, polyamides and polycarbonates.

The present invention relates to condensation products of melamine and phenylphosphonic acid, a process for their preparation, their compositions with polymeric materials and their use as flame retardants in polymer substrates. The compositions are especially useful for the manufacture of flame retardant compounds based on polyfunctional epoxides or polycondensates, such as polyesters, polyamides and polycarbonates.

Flame retardants are added to polymeric materials (synthetic or natural) to enhance the flame retardant properties of the polymers. Depending on their composition, flame retardants may act in the solid, liquid or gas phase either chemically, e.g. as a spumescent by liberation of nitrogen, and/or physically, e.g. by producing a foam coverage. Flame retardants interfere during a particular stage of the combustion process, e.g. during heating, decomposition, ignition or flame spread.

There is still a need for flame retardant compositions with improved properties that can be used in different polymer substrates. Increased standards with regard to safety and environmental requirements result in stricter regulations. Particularly known halogen containing flame retardants no longer match all necessary requirements. Therefore, halogen free flame retardants are preferred, particularly in view of their better performance in terms of smoke density associated with fire. Improved thermal stability and less corrosive behaviour are further benefits of halogen free flame retardant compositions. A widely used class of halogen free flame retardants are polyphosphate salts of 1,3,5-triazines, as, for example, described in WO 00/02869.

Surprisingly it has been found that also condensation products of melamine and phenylphosphonic acid are highly efficient flame retardants. The condensates can be prepared starting from phenylphosphonic acid and melamine. The resulting product is a mixture of polyphenylphosphonate, melamine and condensation products of melamine. Surprisingly the condensation of melamine and of phenylphosphonic acid can be carried out in one step. The resulting product is stable up to 345° C. and is a powerful flame retardant in particular for polymers which need high processing temperatures, such as polyamide, polyester and polycarbonate.

One aspect of the invention is a process for the preparation of a condensation product of melamine and phenylphosphonic acid comprising the steps

a) neutralizing or mixing a phenylphosphonic acid of formula (I)

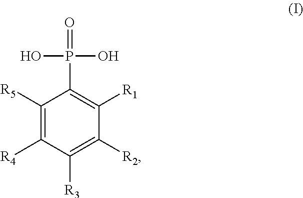

with melamine at a temperature from 20° C. to 100° C. wherein the molar ratio of melamine to the phenylphosphonic acid of formula (I) is equal or greater 1;
R₁-R₅ independently of one another represent hydrogen or a substituent selected from the group consisting of C₁-C₄alkyl, hydroxy, hydroxy-C₁-C₄alkyl and C₁-C₄alkoxy; and
b) reacting the mixture at a temperature between 150° C. to 400° C. to form the condensation product of melamine and the phenylphosphonic acid of formula (I) wherein the melam content is at least 0.1 mol per mole condensation product.

The neutralization step may be carried out in an aqueous slurry which may contain up to 90%, preferably 40% to 60% by weight of solids, based on the weight of the total slurry. In a specific embodiment the neutralization step is carried out in a solid phase reaction, which means that the components are mixed in the solid state.

The temperature of the neutralization step is preferably from 90° C. to 100° C.

Phenylphosphonic acid as a divalent acid can be neutralized by melamine to form melamine hydrogenphenylphosphonate or dimelamin phenylphosphonate depending on the stoichiometric equivalents used for neutralisation. Starting material for the condensation step to form the melamine polyphenylphosphonate comprises both melamine hydrogenphenylphosphonate, dimelaminiume phenylphosphonate or mixtures thereof.

For example the molar ratio between melamine and phenylphosphonic acid is from 1.1:1 to 3:1, for instance it is 2:1.

It is, however, also possible that melamine is present in a molar amount of less than 1 mole per mole of phenylphosphonic acid. In another specific embodiment it can be up to 10 mole per mole of phenylphosphonic acid.

In the neutralisation step of phenylphosphonic acid other components may be present as well, such as inorganic acids like phosphorous containing acid, sulphuric acid, boric acid, silicic acid; organic acids like sulfonic acid, carboxy acid, oxalic acid, the corresponding metal and ammonium salts of these acids, such as sodium phosphate, sodium hydrogene phosphate, sodium dihydrogenephopshate, potassium phosphate, potassium hydrogene phosphate, potassium dihydrogene phosphate, zinc phosphate, calcium phosphate, calcium phosphinate, aluminium phosphate, aluminium diethylphosphinate, ammonium hydrogene phosphate, ammonium sulphate, ammonium hydrogene sulfate; metal oxides like ZnO, MgO, Al₂O₃, TiO₂, SiO₂; metal hydroxides like NaOH, KOH, Ca(OH)₂, ammonia releasing compounds such as urea, carbonic amide, sulphuric amide, sulfonic amide, melam and melem.

In a specific embodiment of the invention R₁ to R₅ are hydrogen.

In the condensation step b) the neutralized melamine phenylphosphonic acid salt is reacted, for example, at a temperature from 280° C. to 350° C., preferably from 300° C. to 340° C. to form the condensation product of melamine and/or the phenylphosphonic acid of formula (I).

The condensation step may be carried out at normal pressure or at a pressure from 1 to 3 bar overpressure or absolute pressure. However, it is preferred to carry out the reaction under reduced pressure; for example, at an absolute pressure from 100 mbar to 0.0001 mbar.

The reaction time may vary from 20 minutes to 20 hours, for instance from 1 hour to 15 hours.

The condensation product of melamine and the phenylphosphonic acid of formula (I) is novel and consequently is also a subject of the instant invention.

The result of the condensation process described above is not one individual compound but a variety of condensation products differing in the degree of condensation of the polyphenylphosphonate and with different counter-ions derived from melamine.

The condensation product of melamine and the phenylphosphonic acid of formula (I) as described above can be represented by the idealized formula (II)

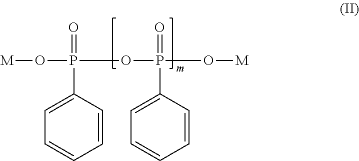

wherein
M is the protonated form of melamine or of a condensation product of melamine and wherein the melam content is at least 0.1 mol per mole condensation product;
   m is a number between 0 and 50, indicating the average degree of condensation of the phenylphosphonate residue.

Another illustration of the condensation product of melamine and the phenylphosphonic acid of formula (I) as described above can be represented by the idealized formula (IIa)

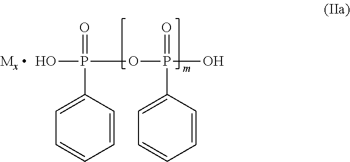

wherein
M is melamine or a condensation product of melamine and wherein the melam content is at least 0.1 mol per mole condensation product;
m is as defined above and
x is from 1-2.

The main condensation products and melamine itself have the following structures:

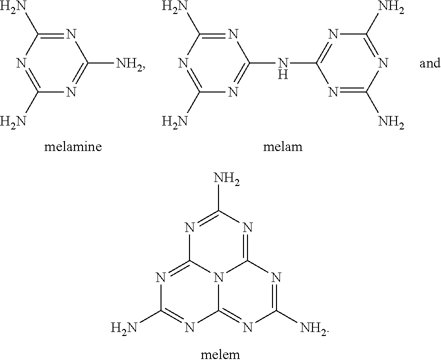 [SMILES: Nc1nc(N)nc(N)n1 ; Nc1nc(N)nc(Nc2nc(N)nc(N)n2)n1 ; NC1=NC2=NC(N)=NC3=NC(N)=NC(=N1)N23]

Melamine and melam are the main components; melem is formed only to a minor degree. In the instant process the amount by weight of melam is substantially higher than the amount of melamine.

The number of repeating units m is preferably from 0 to 30, more preferably from 0 to 3. For example, the experimentally measured average value of m is between 0.2 and 2.5, preferably between 1.1 and 2.5.

An average value for m of greater than 0 is in general desirable.

For example, the condensation product of melamine and the phenylphosphonic acid of formula (I) as described above has a melam content of 2 moles or less of melam per mole of phosphorous atom.

The condensation product of melamine and the phenylphosphonic acid of formula (I) as described above exhibits a pH value of 5 or higher as measured in a 10% by weight slurry in water.

In a specific embodiment the condensation product of melamine and the phenylphosphonic acid of formula (I) as described above comprises as melamine condensate 10%-100% by weight of melam, preferably 20%-90%, more preferably 70%-85%, based on the weight of the melamine plus the weight of the melamine condensation products.

Typically the condensation product of melamine and the phenylphosphonic acid of formula (I) as described above comprises as melamine condensate 10%-100% by weight of melam, preferably 20%-90%, more preferably 70%-85%, based on the weight of melamine plus the weight of the melamine condensation products and comprises an average degree of condensation of the phosphorous containing repeating units m being a number from 1 to 30, preferably from 1 to 4 and more preferably from 1.2 to 3.5.

The molar ratio of melamine to melam typically varies from 0 to 10 (exclusively melam to 10 mole-% melam).

Also an aspect of the invention is a flame retarding composition comprising

a) a condensation product of melamine and the phenylphosphonic acid of formula (I) as described above and
b) a polymer substrate.

The term polymer substrate comprises within its scope thermoplastic polymers or thermosets.

A list of suitable synthetic polymers is given below:
1. Polymers of monoolefins and diolefins, for example polypropylene, polyisobutylene, polybut-1-ene, poly-4-methylpent-1-ene, polyvinylcyclohexane; polyisoprene or polybutadiene, as well as polymers of cycloolefins, for instance of cyclopentene or norbornene, polyethylene (which optionally can be cross linked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE, VLDPE and ULDPE).
   Polyolefins, i.e. the polymers of monoolefins exemplified in the preceding paragraph, preferably polyethylene and polypropylene, can be prepared by different and especially by the following methods:
   a) Radical polymerisation (normally under high pressure and at elevated temperature);
   b) Catalytic polymerisation using a catalyst that normally contains one or more than one metal of groups IVb, Vb, Vlb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch;
   The homopolymers and copolymers mentioned above may have a stereo structure including syndiotactic, isotactic, hemi-isotactic or atactic; where atactic polymers are preferred. Stereo block polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included:
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene;
   b) Hydrogenated aromatic polymers derived from hydrogenation of polymers mentioned under 6), especially including polycyclohexylethylene (PCHE) prepared by hydrogenating atactic polystyrene, often referred to as polyvinylcyclohexane (PVCH);
   c) Hydrogenated aromatic polymers derived from hydrogenation of polymers mentioned under 6a). Homopolymers and copolymers may have a stereo structure including syndiotactic, isotactic, hemi-isotactic or atactic; where atactic polymers are preferred. Stereo block polymers are also included.
7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrite/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes, which contain ethylene oxide as a comonomer; polyacetals modified with thermoplastic polyurethanes, acrylates or MBS.
14. Polyphenylene oxides and sulphides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
17. Polyureas, polyimides, polyamide imides, polyether imides, polyester imides, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Polyketones.
20. Polysulphones, polyether sulphones and polyether ketones.
21. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
22. Polycarbonates that correspond to the general formula:

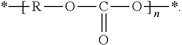

Such Polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.

Preferred are polycarbonates obtainable by reaction of a diphenol, such as bisphenol A, with a carbonate source. Examples of suitable diphenols are:

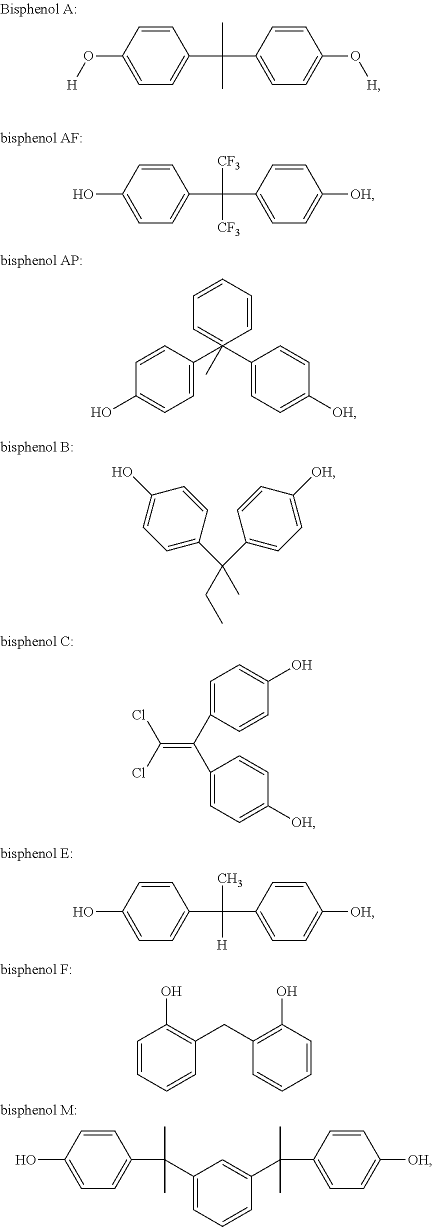

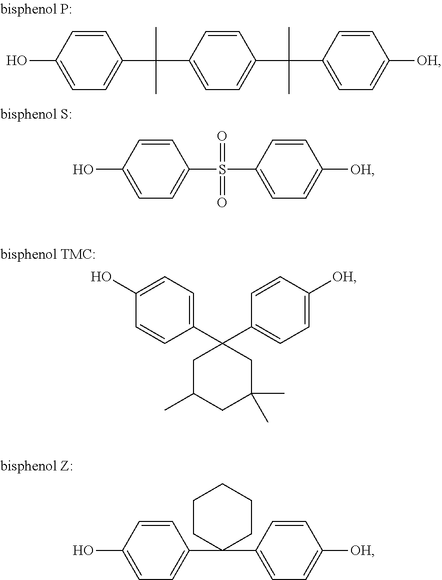 [SMILES: CC(C)(c1ccc(O)cc1)c1ccc(C(C)(C)c2ccc(O)cc2)cc1 ; O=S(=O)(c1ccc(O)cc1)c1ccc(O)cc1 ; CC1CC(C)(C)CC(c2ccc(O)cc2)(c2ccc(O)cc2)C1 ; Oc1ccc(C2(c3ccc(O)cc3)CCCCC2)cc1]

4,4′-(2-norbornylidene)bis(2,6-dichlorophenol); or
fluorene-9-bisphenol:

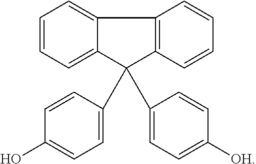 [SMILES: Oc1ccc(C2(c3ccc(O)cc3)c3ccccc3-c3ccccc32)cc1]

The carbonate source may be a carbonyl halide, a carbonate ester or a haloformate. Suitable carbonate halides are phosgene or carbonylbromide. Suitable carbonate esters are dialkylcarbonates, such as dimethyl- or diethylcarbonate, diphenyl carbonate, phenyl-alkylphenylcarbonate, such as phenyl-tolylcarbonate, dialkylcarbonates, such as dimethyl- or diethylcarbonate, di-(halophenyl)carbonates, such as di(chlorophenyl)carbonate, di-(bromophenyl)carbonate, di-(trichlorophenyl)carbonate or di-(trichlorophenyl)carbonate, di-(alkylphenyl)carbonates, such as di-tolylcarbonate, naphthylcarbonate, dichloronaphthylcarbonate and others.

The polymer substrate mentioned above, which comprises polycarbonates or polycarbonate blends is a polycarbonate-copolymer, wherein isophthalate/terephthalate-resorcinol segments are present. Such polycarbonates are commercially available, e.g. Lexan® SLX (General Electrics Co. USA). Other polymeric substrates of component b) may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and PVC, including suitable compatibilizing agents. For example, the polymer substrate may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycolmodified polycyclohexylenemethylene terephthalate (PCTG), polysulphone (PSU), polymethylmethacrylate (PMMA), thermoplastic polyurethane (TPU), acrylonitrilebutadiene-styrene (ABS), acrylonitrile-styrene-acrylic ester (ASA), acrylonitrileethylene-propylene-styrene (AES), styrene-maleic anhydride (SMA) or high impact polystyrene (HIPS).

In a specific embodiment of the invention the polymer substrate is selected from the group consisting of polyfunctional epoxide compounds and hardener compounds.

Examples of a polyfunctional epoxide compound are compounds, wherein at least two epoxy groups of the partial formula

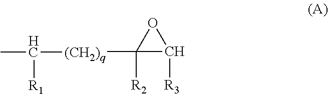

are present, which are attached directly to carbon, oxygen, nitrogen or sulphur atoms, and wherein q represents zero, R₁ and R₃ both represent hydrogen and R₂ represents hydrogen or methyl; or wherein q represents zero or 1, R₁ and R₃ together form the —CH₂—CH₂— or —CH₂—CH₂—CH₂— groups and R₂ represents hydrogen.

Examples of polyfunctional epoxide compounds are:

I) Polyglycidyl esters and poly(β-methylglycidyl) esters obtainable by reacting a compound having at least two carboxyl groups in the molecule with epichlorohydrin and/or glyceroldichlorohydrin and/or β-methylepichlorohydrin. The reaction is carried out in the presence of bases.

Suitable compounds having at least two carboxyl groups in the molecule are aliphatic polycarboxylic acids, such as glutaric, adipic, pimelic, suberic, azelaic, sebacic or dimerized or trimerized linoleic acid. Cycloaliphatic polycarboxylic acids are suitable, e.g. tetrahydrophthalic, 4-methyltetrahydrophthalic, hexahydrophthalic or 4-methylhexahydrophthalic acid.

Aromatic polycarboxylic acids are suitable, such as phthalic, isophthalic, trimellitic and pyromellitic acid. Likewise suitable are carboxyl-terminated adducts of, for example, trimellitic acid and polyols such as glycerol or 2,2-bis(4-hydroxycyclohexyl)propane.

II) Polyglycidyl ethers or poly(β-methylglycidyl)ethers obtainable by reacting a compound having at least two free alcoholic hydroxyl groups and/or phenolic hydroxyl groups with a suitably substituted epichlorohydrin under alkaline conditions or in the presence of an acidic catalyst with subsequent treatment under alkaline conditions.

Ethers of this type are derived, for example, from straight-chained alcohols, such as ethyleneglycol, diethyleneglycol and higher poly(oxyethylene)glycols, propane-1,2-diol, or poly(oxypropylene)glycols, propane-1,3-diol, butane-1,4-diol, poly(oxytetramethyllene)glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins.

In the alternative, they are derived, for example, from cycloaliphatic alcohols, such as 1,3- or 1,4-dihydroxycyclohexane, bis(4-hydroxycyclohexyl)methane, 2,2-bis(4-hydroxycyclohexyl)-propane or 1,1-bis(hydroxymethyl)cyclohex-3-ene, or they possess aromatic nuclei, such as N,N-bis(2-hydroxyethyl)aniline or p,p′-bis(2-hydroxyethylamino)diphenylmethane.

The epoxy compounds may also be derived from mononuclear phenols, such as resorcinol or hydroquinone; or they are based on polynuclear phenols, such as bis(4-hydroxyphenyl)methane, 2,2-bis(4-hydroxyphenyl)propane, 2,2-bis(3,5-dibromo-4-hydroxyphenyl)-propane or 4,4′-dihydroxydiphenyl sulphone, or on condensates of phenols with formaldehyde that are obtained under acidic conditions, such as phenol Novolak®.

III) Poly(N-glycidyl) compounds obtainable by dehydrochlorinating the reaction products of epichlorohydrin with amines containing at least two amino hydrogen atoms. These amines are, for example, aniline, toluidine, n-butylamine, bis(4-aminophenyl)methane, m-xylylenediamine or bis(4-methylaminophenyl)methane, and also N,N,O-triglycidyl-m-aminophenol or N,N,O-triglycidyl-p-aminophenol.

The poly(N-glycidyl) compounds also include N,N′-diglycidyl derivatives of cycloalkylene-ureas, such as ethylene urea or 1,3-propyleneurea, and N,N′-diglycidyl derivatives of hydantoins, such as of 5,5-dimethylhydantoin.

IV) Poly(S-glycidyl) compounds, such as di-S-glycidyl derivatives derived from dithiols, such as ethane-1,2-dithiol or bis(4-mercaptomethylphenyl)ether.

Epoxy compounds having a radical of the formula A, in which R₁ and R₃ together are —CH₂—CH₂— and n is 0 are bis(2,3-epoxycyclopentyl)ether, 2,3-epoxycyclopentyl glycidyl ether or 1,2-bis(2,3-epoxycyclopentyloxy) ethane. An example of an epoxy resin having a radical of the formula A in which R₁ and R₃ together are —CH₂—CH₂— and n is 1 is (3,4-epoxy-6-methylcyclohexyl)methyl 3′,4′-epoxy-6′-methylcyclohexanecarboxylate.

Polyfunctional epoxide compounds are known. Many of them are commercially available from Huntsman Advanced Materials (brand name Araldite®). Examples of suitable polyfunctional epoxides are:

a) Liquid bisphenol A diglycidyl ethers, such as ARALDITE GY 240, GY 250, GY 260, GY 266, GY 2600, MY 790, DER® 332, 331, Hexion® EPR 158, Tactix® 123 and 138, or Epon® 826;
b) Solid bisphenol A diglycidyl ethers such as ARALDITE GT 6071, GT 7071, GT 7072, GT 6063, GT 7203, GT 6064, GT 7304, GT 7004, GT 6084, GT 1999, GT 7077, GT 6097, GT 7097, GT 7008, GT 6099, GT 6608, GT 6609, GT 6610, CT 200 and 6100 ES, Epikote® 1001 and 109, and DER® 661, 667 and 668 and DLS 1065 ES;
c) Liquid bisphenol F diglycidyl ethers, such as ARALDITE GY 281, GY 282, PY 302, and PY 306;
d) Solid polyglycidyl ethers of tetraphenylethane, such as CG Epoxy Resin®0163;
e) Solid and liquid polyglycidyl ethers of phenol-formaldehyde Novolak®, such as EPN 1138, EPN 1139, GY 1180, PY 307, Epon® 828 and Tactix® 556;
f) Solid and liquid polyglycidyl ethers of o-cresol-formaldehyde NOVOLAK, such as ECN 1235, 1273, 1280 and ECN 1299;
g) Liquid glycidyl ethers of alcohols, such as Shell®glycidyl ether 162, ARALDITE DY 0390, and DY 0391;
h) Liquid glycidyl ethers of carboxylic acids, such as Shell®Cardura E terephthalic ester, trimellitic ester, and PY 284;
i) Solid heterocyclic epoxy resins (triglycidyl isocyanurate), such as ARALDITE PT 810;
k) Liquid cycloaliphatic epoxy resins, such as ARALDITE CY 179;
l) Liquid N,N,O-triglycidyl ethers of p-aminophenol, such as ARALDITE MY 0510;
m) Tetraglycidyl-4,4′-methylenebenzamine or N,N,N′,N′-tetraglycidyldiaminophenylmethane, such as ARALDITE MY 720, and MY 721;
n) N,N,N′,N′-tetraglycidyl-m-xylidenediamine, such as Tetrad®-X;
o) Triglycidyl ether, of 1,1,2,-tris(4-hydroxyphenyl)ethane, such as Tactix® 742.

If desired, a mixture of epoxy compounds of different structure can also be employed. Suitable polyfunctional epoxide compounds preferably comprise at least two groups of the formula

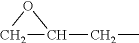

Particular preference as component is given to the following compounds of types and/or mixtures of them

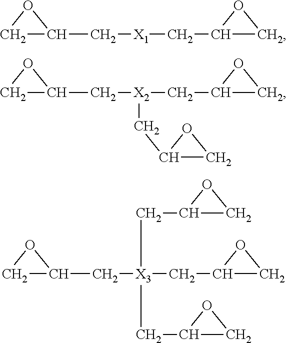

Wherein X₁, X₂ and X₃ are cyclohexylene, phenylene or naphthylene which can be unsubstituted or substituted and X₁ is additionally an unsubstituted or substituted radical of the partial formula

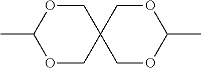

and X₂ is additionally an unsubstituted or substituted radical of the partial formula

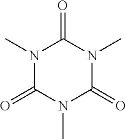

Suitable substituents for the abovementioned radicals are —O—, —S—, —C(═O)—, —C(═O)—O—, —S(═O)—, —S(O₂)—, —C(CF₃)₂—, alkyl, alkylene, aryl, arylene, alkoxy, aryloxy or halogen. Identical or different substituents may be present two or more times, whereas the substituents themselves may likewise be further substituted.

An example of a suitable alkyl radical is a C₁-C₁₈alkyl radical; such as methyl, ethyl, n-propyl, n-butyl, sec-butyl, tert-butyl, n-hexyl; n-octyl, 2-ethylhexyl, n-nonyl, n-decyl, n-undecyl, n-dodecyl, n-tridecyl, n-tetradecyl, n-hexadecyl or n-octadecyl, and their branched isomers.

Possible alkylene and alkoxy radicals can be derived formally from the abovementioned alkyl radicals by removing a further hydrogen atom or, respectively, by adding an oxygen atom.

Examples of suitable aryl radicals are those having 6-20 carbon atoms, such as phenylene, biphenylene or naphthylene.

Possible arylene and aryloxy radicals can be derived formally from the abovementioned aryl radicals by removing a further hydrogen atom or, respectively, by adding an oxygen atom.

Preference is given to radicals of the following formulae:

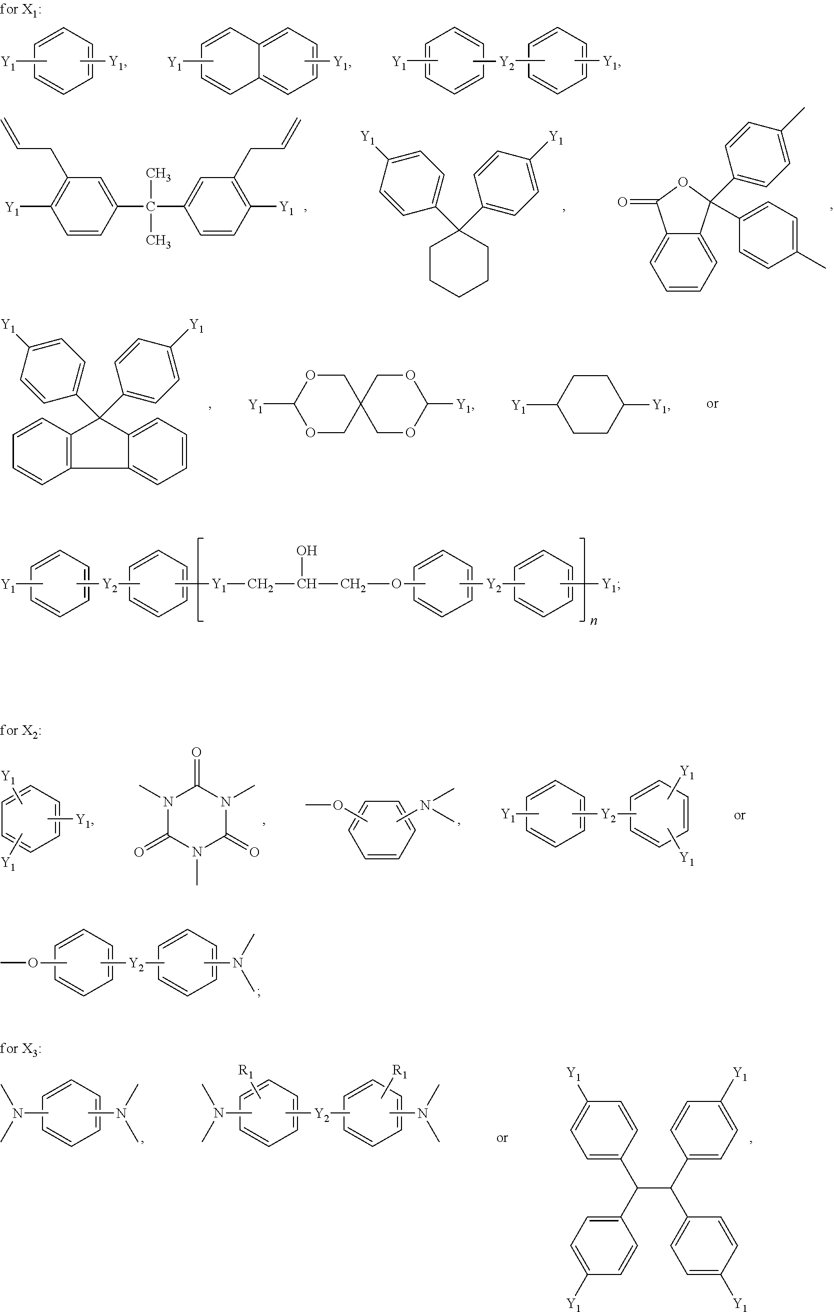

in which
Y₁ is a direct bond or the groups —O—, —S— or —C(═O)—O—;
Y₂ is a direct bond or the groups —SO₂—, —CO—, —S—, —SO—, CH₂—, —C(CH₃)₂— or —C(CF₃)₂—;

### And n is 1-10.

The aromatic rings are unsubstituted or substituted one or more times by alkyl, aryl, alkoxy, aryloxy or halogen, as described in more detail above.

Particular preference is given to the following compounds:

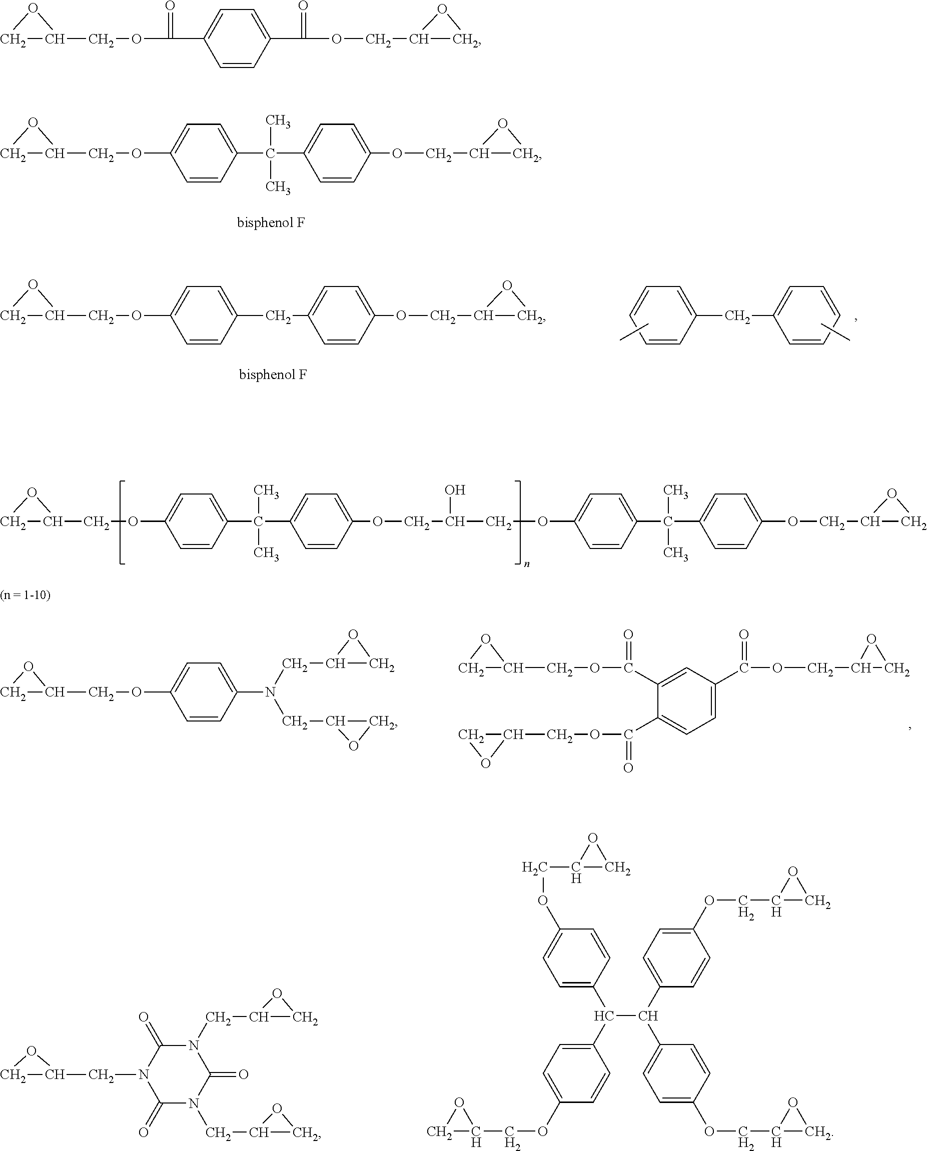

A suitable hardener compound is any of the known hardeners for epoxy resins. The amine, phenolic and anhydride hardeners are particularly preferred, such as polyamines, e.g. ethylenediamine, diethylenetriamine, triethylenetriamine, hexamethylenediamine, methanediamine, N-aminoethyl piperazine, diaminodiphenylmethane [DDM], alkyl-substituted derivatives of DDM, isophoronediamine [IPD], diaminodiphenylsulphone [DDS], 4,4′-methylenedianiline [MDA], or m-phenylenediamine [MPDA]), polyamides, alkyl/alkenyl imidazoles, dicyandiamide [DICY], 1,6-hexamethylene-bis-cyanoguanidine, phenolic hardeners such as phenol novolac and cresol novolac, or acid anhydrides, e.g. dodecenylsuccinic acid anhydride, hexahydrophthalic acid anhydride, tetrahydrophthalic acid anhydride, phthalic acid anhydride, pyromellitic acid anhydride, and derivatives thereof.

A preferred embodiment of the invention relates to a composition, which comprises a polyfunctional epoxide compound a hardener compound that contains at least two amino groups, such as dicyandiamide.

In another specific embodiment the polymer substrate is a thermoplastic polymer substrate, preferably a polyester, polyamide, polysulfone or polycarbonate substrate.

Another aspect of the invention is a process for imparting flame retardancy to a polymer substrate, which process comprises adding to a polymer substrate a melamine polyphenylphosphonate salt as defined above.

In a preferred process the polymer substrate is a polyester, polyamide, polysulfone or polycarbonate substrate.

In another preferred process the polymer substrate is selected from the group consisting of polyfunctional epoxide compounds and hardener compounds.

In the process and in the composition the melamine polyphenylphosphonate salt as defined above is typically present in an amount from 1% to 45 by weight, preferably 10% to 30% based on the weight of the polymer.

The weight ratio between the polyfunctional epoxide and the hardener is usually from 2:1 to 1:1.

For example additionally a further additive is added to the composition or process which additive is selected from the group consisting of anti-dripping agents, polymer stabilizers and additional flame retardants, such as phosphorus containing flame-retardants, nitrogen containing flame retardants, halogenated flame-retardants and inorganic flame-retardants.

In one embodiment, the invention relates to a composition which comprises as additional component so-called anti-dripping agents.

These anti-dripping agents reduce the melt flow of the thermoplastic polymer and inhibit the formation of drops at high temperatures. Various references, such as U.S. Pat. No. 4,263,201, describe the addition of anti-dripping agents to flame retardant compositions.

Suitable additives that inhibit the formation of drops at high temperatures include glass fibers, polytetrafluoroethylene (PTFE), high temperature elastomers, carbon fibers, glass spheres and the like.

The addition of polysiloxanes of different structures has been proposed in various references; cf. U.S. Pat. No. 6,660,787, 6,727,302 or 6,730,720.

Stabilizers are preferably halogen-free and selected from nitroxyl stabilizers, nitrone stabilizers, amine oxide stabilizers, benzofuranone stabilizers, phosphite and phosphonite stabilizers, quinone methide stabilizers and monoacrylate esters of 2,2′-alkylidenebisphenol stabilizers.

According to a preferred embodiment of the invention, the composition comprises an additional flame retardant component. Such additional flame retardants are known components, items of commerce or can be obtained by known methods.

Other representative phosphorus containing flame retardants, in addition to the ones defined above, are for example:

Tetraphenyl resorcinol diphosphate (Fyrolflex® RDP, Akzo Nobel), resorcinol diphosphate oligomer (RDP), tetrakis(hydroxymethyl)phosphonium sulphide, triphenyl phosphate, diethyl-N,N-bis(2-hydroxyethyl)aminomethyl phosphonate, hydroxyalkyl esters of phosphorus acids, salts of hypophosphoric acid (H₃PO₂) formed with e.g. Ca²⁺, Zn²⁺, or Al³⁺ as cations, aluminium diethylphosphinate, zinc diethylphopsphinate, ammonium polyphosphate (APP) or (Hostaflam® AP750), resorcinol diphosphate oligomer (RDP), phosphazene flame-retardants and ethylenediamine diphosphate (EDAP).

Nitrogen containing flame-retardants are, for example, isocyanurate flame-retardants, such as polyisocyanurate, esters of isocyanuric acid or isocyanurates. Representative examples are hydroxyalkyl isocyanurates, such as tris-(2-hydroxyethyl)isocyanurate, tris(hydroxymethyl)isocyanurate, tris(3-hydroxy-n-propyl)isocyanurate or triglycidyl isocyanurate.

Nitrogen containing flame-retardants include further melamine-based flame-retardants. Representative examples are: melamine cyanurate, melamine borate, melamine phosphate, melamine pyrophosphate, melamine polyphosphate, melamine ammonium polyphosphate, melamine ammonium pyrophosphate, dimelamine phosphate, dimelamine pyrophosphate.

Further examples are: benzoguanamine, tris(hydroxyethyl)isocyanurate, allantoin, glycoluril, melamine cyanurate, melamine phosphate, dimelamine phosphate, melamine pyrophosphate, urea cyanurate, ammonium polyphosphate, a condensation product of melamine from the series melem, melam, melon and/or a higher condensed compound or a reaction product of melamine with phosphoric acid or a mixture thereof.

Representative inorganic flame retardants include, for example, aluminum trihydroxide (ATH), boehmite (AlOOH), magnesium dihydroxide (MDH), zinc borates, CaCO₃, layered silicates or layered double hydroxides modified with organic substituents, and mixtures thereof.

Representative organohalogen flame retardants are, for example:

Polybrominated diphenyl oxide (DE-60F, Great Lakes Corp.), decabromodiphenyl oxide (DBDPO; Saytex® 102E), tris[3-bromo-2,2-bis(bromomethyl)propyl]phosphate (PB 370®, FMC Corp.), tris(2,3-dibromopropyl)phosphate, tris(2,3-dichloropropyl)phosphate, chlorendic acid, tetrachlorophthalic acid, tetrabromophthalic acid, poly-β-chloroethyl triphosphonate mixture, tetrabromobisphenol A bis(2,3-dibromopropyl ether) (PE68), brominated epoxy resin, ethylenebis(tetrabromophthalimide) (Saytex® BT-93), bis(hexachlorocyclopentadieno)cyclooctane (Declorane Plus®), chlorinated paraffins, octabromodiphenyl ether, hexachlorocyclopentadiene derivatives, 1,2-bis(tribromophenoxy)ethane (FF680), tetrabromobisphenol A (Saytex® RB100), ethylene bis-(dibromo-norbornanedicarboximide) (Saytex® BN-451), bis-(hexachlorocycloentadeno) cyclooctane, PTFE, tris-(2,3-dibromopropyl)-isocyanurate, and ethylene-bis-tetrabromophthalimide.

The organohalogen flame retardant mentioned above routinely combined with an inorganic oxide synergist. Most common for this use are zinc or antimony oxides, e.g. Sb₂O₃ or Sb₂O₅. Boron compounds are suitable, too.

The above-mentioned additional flame-retardant classes are advantageously contained in the composition of the invention in an amount from about 0.5% to about 45.0% by weight of the organic polymer substrate; for instance about 1.0% to about 40.0%; for example about 5.0% to about 35.0% by weight of the polymer or based on the total weight of the composition.

As mentioned above, the composition according to the invention may additionally contain one or more conventional additives, for example selected from pigments, dyes, plasticizers, antioxidants, thixotropic agents, levelling assistants, basic co-stabilizers, metal passivators, metal oxides, organophosphorus compounds, further light stabilizers and mixtures thereof, especially pigments, phenolic antioxidants, calcium stearate, zinc stearate, UV absorbers of the 2-hydroxy-benzophenone, 2-(2′-hydroxyphenyl)benzotriazole and/or 2-(2-hydroxyphenyl)-1,3,5-triazine groups.

Preferred additional additives for the compositions as defined above are processing stabilizers, such as the above-mentioned phosphites and phenolic antioxidants, and light stabilizers, such as benzotriazoles. Preferred specific antioxidants include octadecyl 3-(3,5-di-tert-butyl-4-hydroxyphenyl)propionate (IRGANOX 1076), pentaerythritoltetrakis[3-(3,5-di-tert-butyl-4-hydroxyphenyl)propionate] (IRGANOX 1010), tris(3,5-ditert-butyl-4-hydroxyphenyl)isocyanurate (IRGANOX 3114), 1,3,5-trimethyl-2,4,6-tris(3,5-di-tert-butyl-4-hydroxybenzyl)benzene (IRGANOX 1330), triethyleneglycol-bis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098). Specific processing stabilizers include tris(2,4-di-tert-butylphenyl) phosphite (IRGAFOS 168), 3,9-bis(2,4-di-tert-butylphenoxy)-2,4,8,10-tetraoxa-3,9-diphosphaspiro[5.5]undecane (IRGAFOS 126), 2,2′,2″-nitrilo[triethyl-tris(3,3′,5,5′-tetratert-butyl-1,1′-biphenyl-2,2′-diyl)]phosphite (IRGAFOS 12), and tetrakis(2,4-di-tert-butylphenyl)[1,1-biphenyl]-4,4′-diyl)bisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(sec-butyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

The additives mentioned above are preferably contained in an amount of 0.01 to 10.0%, especially 0.05 to 5.0%, relative to the weight of the polymer substrate b).

The incorporation of the components defined above into the polymer component is carried out by known methods such as dry blending in the form of a powder, or wet mixing in the form of solutions, dispersions or suspensions for example in an inert solvent, water or oil. The additive components a) and b) and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc.), e.g. as a dry mixture or powder, or as a solution or dispersion or suspension or melt.

The addition of the additive components to the polymer substrate can be carried out in customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contra-rotating and co-rotating twin-screw extruders, planetary-gear extruders, ring extruders or co-kneaders. It is also possible to use processing machines provided with at least one gas removal compartment to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components is added, these can be premixed or added individually.

The additive components a) and optional further additives can also be sprayed onto the polymer substrate b). The additive mixture dilutes other additives, for example the conventional additives indicated above, or their melts so that they can be sprayed also together with these additives onto the polymer substrate. Addition by spraying during the deactivation of the polymerisation catalysts is particularly advantageous; in this case, the steam evolved may be used for deactivation of the catalyst. In the case of spherically polymerised polyolefins it may, for example, be advantageous to apply the additives of the invention, optionally together with other additives, by spraying.

The additive components a) and optional further additives can also be added to the polymer in the form of a master batch (“concentrate”) which contains the components in a concentration of, for example, about 1.0% to about 40.0% and preferably 2.0% to about 20.0% by weight incorporated in a polymer. The polymer is not necessarily of identical structure than the polymer where the additives are added finally. In such operations, the polymer can be used in the form of powder, granules, solutions, and suspensions or in the form of lattices.

Incorporation can take place prior to or during the shaping operation. The materials containing the additives of the invention described herein preferably are used for the production of molded articles, for example roto-molded articles, injection molded articles, profiles and the like, and especially a fibre, spun melt non-woven, film or foam.

Yet another aspect of the invention is the use of a condensation product of melamine and the phenylphosphonic acid of formula (I) as described above as flame retardant additive for polymers.

Still a further aspect of the invention is a product of formula III

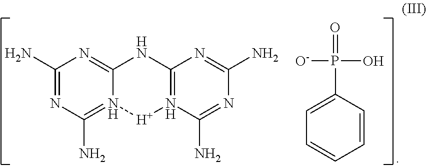

The definitions and preferences given above apply equally for all aspects of the invention.

The following examples illustrate the invention.

### A) PREPARATION EXAMPLES

### Example A1 (Precursor)

### Melamine Phenylhydrogenphosphonate (MPPO)

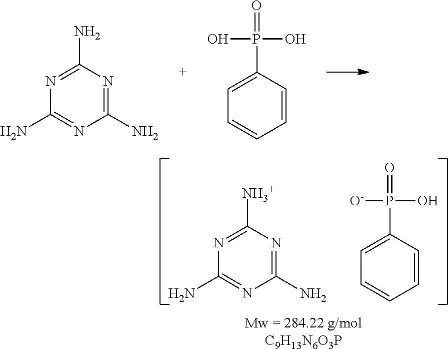

In a 4 l flask equipped with thermometer and stirrer (power stirrer: IKA-RW20, two-stage-stirrer) melamine (252 g, 2.0 mol, purchased from Aldrich) is suspended within 15 min in water (3.01) at 95° C. (stirring at step 1.5). Phenylphosphonic acid (316 g, 2.0 mol purchased from Aldrich) is added to the suspension at 98° C. in 23 portions within 20 minutes.

The reaction mixture is stirred for 90 min at 95-100° C. The formed suspension of crystals is stirred for 90 min at 95° C. and cooled to 60° C. within 60 min. The crystal suspension is filtered and the crystals are washed with 500 mL destilled water. The obtained crystals are dried in a vacuum oven at 60° C., 1-10 mbar for 17 h. Additional drying is carried out at 130° C./1-10 mbar for 17 h.

Yield:

1. crystal fraction 89% by theory,

2. crystal fraction from the mother liquor: 6% by theory

Solubility in water: 11 g/L (25° C.); 70 g/L (95° C.)

Phosphorous content: 10.9%

Decomposition by TGA: onset 277° C. (−12%)

Melting point.: 268-270° C.

c-DTA: onset 280.3° C.

³¹P-NMR (D₂O): 18.3 ppm

### Example A2

### Condensation of Melamine Hydrogenphenylphosphonate (MPPO)

Melamine hydrogenphenylphosphonate (MPPO) from example 1 (10.000 g, 0.04 mol) is tempered in a glass tube at 300° C./5·10⁻¹ mbar for 2 h and additional for 22 h. The mass balance is monitored for the residual by gravimetrically methods. The obtained product is characterized by phosphorous content, 1,3,5-triazine components and thermogravimetry.

| Time [h] | 2 | 22 |
|---|---|---|
| Residual mass [g] | 6.9708 | 6.8639 |
| Mass loss [g, w %] | 3.03, 30.3 | 3.14, 31.4 |
| Phosphorous content [%] | 12.0 | 13.9 |
| Melamine/Melam/Melem content | 26.1/70.1/<3.7 | 8.9/86.7/4.4 |
| (rel. %) | | |

Decomposition by TGA: onset 345-351° C.; mass loss at 496° C.: 54.5%

Based on the analysis of the 1,3,5-triazine components the melam content is calculated to 70-87%.

### Example A3

### Condensation of Melamine Hydrogenphenylphosphonate (MPPO)

A high temperature two shaft-kneader (Zweiwellenkneter LIST CRP 2.5) is loaded with 1,335 kg of melamine hydrogenphenylphosphonate (MPPO) from example 1. The stirrer speed is set to 35 Upm. The jacket of the kneader is heated to 250° C. and the resulting reaction mass temperature was 220° C. By an increasing temperature gradient the evolution of ammonia is observed in an endothermic phase at 270° C. (jacket temperature 300° C.). The maximum of ammonia evolution is determined to 40 g NH3/(kg MPPO h). After 3 h the reactor was cooled to room temperature and the reaction product is unloaded (1,165 kg). The product is characterized by mass balance, phosphorus content and melamine and melamine condensation components.

Mass loss: 12.7 w %

Phosphorous content: 11.2 w %

Melamine/Melam/Melem content (rel. %): 26.0/69.9/<4.1

### Example A4

### Condensation of Melamine Hydrogenphenylphosphonate (MPPO)

A high temperature two shaft-kneader (Zweiwellenkneter LIST CRP 2.5) is loaded with 1,335 kg of melamine hydrogenphenylphosphonate (MPPO) from example 1. The stirrer speed is set 35 Upm. The reaction mass is heated with a jacket temperature of 360° C. directly to 270° C. The ammonia formation is observed in an endothermic phase at 270° C. (jacket temperature 360° C.). The maximum of ammonia evolution is determined to 55 g NH3/(kg MPPO h). After 3 h the reaction product (0.905 kg) is characterized by mass balance, phosphorus content and content of melamine and melamine condensation components.

Mass loss: 32.2 w %

Phosphorous content: 14.8 w %

Melamine/Melam/Meleme content (rel. %): 25.5/<9.4/65.1

### Example A5

### Melam Phenylhydrogenphosphonate

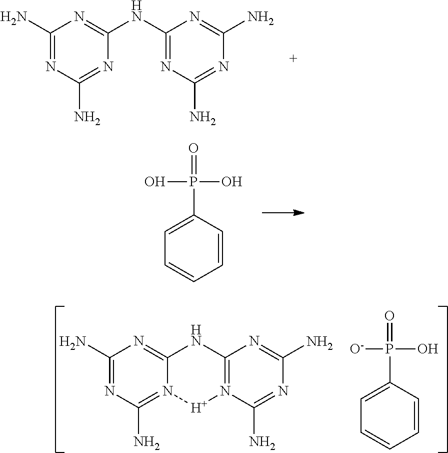

Melam (58.8 g, 0.25 mol; prepared by literature methods) is suspended in water (1330 ml) and heated to 95° C. Phenyl phosphonic acid (39.5 g, 0.25 mol, Aldrich) is added in portions. The reaction mixture is stirred for 4 h at 95° until pH 6 is reached. A fine crystal suspension is formed. After cooling to 25° C. 1500 mL ethanol is added to the reaction mixture and the product is isolated after filtration as fine white needles. The obtained crystals are dried in a vacuum oven at 60° C., 1-10 mbar for 17 h. Additional drying is carried out at 130° C./1-10 mbar for 17 h.

Yield: 91.9 g, 93.5% by theory

Phosphorous content: 7.8%

Nitrogen content: 38.7%

Decomposition by TGA: onset 345° C. (−4.5%, 1 molÄq H₂O); onset 372° C. (−55%).

The following table depicts the analytical data of compounds (examples A1-A5) in an overview:

| Example | A1 | A2 | A3 | A4 | A5 |
|---|---|---|---|---|---|
| Elemtal formula | C9H13N6O3P | | | | C12H16N11O3P |
| Molar mass [g/mol] | 284 | | | | 393 |
| Reaction conditions | | | | | |
| Temperature [° C.] | | 300 | 280 | 330 | |
| pressure [mbar] | | 5*10−3 | 1023 | 1023 | |
| Elementary Analysis[%] | | | | | |
| C | 38.0 | — | 39.2 | 36.3 | 36.6 |
| H | 4.6 | — | 4.2 | 3.6 | 4.1 |
| N | 29.6 | — | 29.2 | 32.2 | 39.2 |
| O | 16.9 | — | 15.2 | 12.4 | 12.2 |
| P | 10.9 | 13.9 | 11.2 | 14.8 | 7.9 |
| Base composition by LC [rel. %] | | | | | |
| Melamin | | 8.9 | 26.0 | 25.5 | |
| Melam | | 86.7 | 69.9 | <9.4 | |
| Melem | | 4.4 | <4.1 | 65.1 | |
| TGA | | | | | |
| onset [° C.] | 277 | 345-351 | 329 | 325 | 345 |
| Mass loss at T ° C. [%] | 320 [−10%] | 420 [−55] | 375 [−48] | 400 [−29] | 372 [−15%] |
| condensate loss | — | 29.3 | 12.7 | 32.2 | |
| to starting mass MPPO [%] | | | | | |

Based on the results of the thermo gravimetric analysis (TGA) of the compounds in examples A1-A5 one can conclude that the condensation of melamine hydrogene phenyphosphonate occurs in a two step mode. The condensation of the melamine to melam starts at 277° C., the condensation of the phenyl phosphonic anions is observed between 300 and 350° C. according to the TGA data of example A5. The mode of condensation therefore may be controlled in a balanced thermometric and stoichiometric approach. According to example A2-A4 in a temperature range of 280-300° C. melam formation is favoured. However, other temperature profiles could be more suitable for other stoichiometric ratios. The increasing phosphorous content in the compounds of example A2-A3 in comparison to example A5 points to the condensation of phenylphosphonic anions.

The formation of melem very likely occurs at temperature above 330° C. The composition of the nitrogen containing bases depends strongly on the physical conditions chosen for the reaction.

### B) APPLICATION EXAMPLES

### Example B1

### Epoxy Laminating/Hot Pressing Procedure

A resin formulation is prepared by dissolving various quantities of Araldite® ECN 1280 resin in 25 phr of methoxy-2-propanol at 95° C. To this solution, 0.04 phr of 2-methylimidazole, 8.1 phr of DICY (dissolved in a 1:1 mixture of methoxy-2-propanol and DMF) and the appropriate quantity of flame retardants as listed in Table 1 are added and dispersed homogeneously.

The formulation is then hot coated onto a piece of glass cloth (type 7628) and heated to 170° C. for about 1-3 min in a forced draft oven. The fiber, now a non-tacky prepreg, is then cut into seven strips (˜180×180 mm) which are stacked upon one another in a distance holder (to assure the manufacture of laminates with uniform thicknesses of 1.5 mm) and with two PTFE plates (1 mm thickness) up- and downside of the prepreg stack. The stack is then placed on a hot press, and the stacked prepregs are subjected to a pressure of 3 bar at 170° C. for a period of 2 h.

The resulting laminate is then removed from the press, cooled to ambient temperature, and separated from the distance holder and PTFE plates. The laminate is then cut to a piece of ˜150×150 mm by cutting off the edges with varying amounts of resin, weighed, its thickness measured, and its percent resin content determined.

### Epoxy Flammability Testing Procedure

The laminate was then cut into five strips (125×13.0 mm), conditioned for 48 h at 23° C. and 50% relative humidity, and subsequently tested in the previously described UL-94 flammability test. The data obtained in this test are presented in Table 2.

TABLE 2
UL94 V (1.6 mm) test results obtained with epoxy laminates
containing different flame retardant compositions

| | | P | resin | UL94 | | |
|---|---|---|---|---|---|---|
| | FR | content | content of | total | | |
| | additive(s) | in resin | laminate | burning | UL94 | T_{dela} |
| Example | [wt. %] | [wt. %] | [wt. %] | time [s] | rating | [° C.]^{a)} |
| Comp. 1 | w/o | 0.0 | 37.8 | 215 | n.c. | 288 |
| | | | | | | 288 |
| Comp. 2 | 16% melamine | 1.7 | 45.8 | 33 | V-0 | 256 |
| | hydrogen- | | | | | 258 |
| | phenyl- | | | | | |
| | phosphonate | | | | | |
| | (example A1) | | | | | |
| Example 1 | 16% | 2.4 | 42.8 | 33 | V-0 | 255 |
| | condensation | | | | | 265 |
| | product of | | | | | |
| | example A4 | | | | | |
| Example 2 | 22% melam | 1.7 | 48.6 | 32 | V-0 | 269 |
| | hydrogen- | | | | | 277 |
| | phenyl- | | | | | |
| | phosphonate | | | | | |
| | (example A5) | | | | | |

^{a)}Temperature of delamination, as determined by TMA according to IPC-TM-650, 2.4.24.1; the results of two independent measurements obtained with different specimens of each laminate are reported.

The results presented above demonstrate that the inventive resin compositions exhibit improved thermal stability compared to non-condensed melamine phenylhydrogenphosphonate while maintaining excellent flame retardant properties (UL94 V-0 classification).

### Components Used:

Epoxy resin formulation and prepreg manufacture:

o-Cresol novolak epoxy resin: Araldite® ECN 1280, Huntsman Advanced Materials, Basel, Switzerland.

Hardener: Dicyandiamide (DICY); accelerator: 2-methylimidazole, both Aldrich, Germany.

Solvents: Methoxy-2-propanol, dimethylformamide (DMF), both Merck Eurolab, Germany).

Glass cloth: Type 7628, P-D Interglas Technologies AG, Germany

### Flame Retardant Additives:

Melam hydrogenphenylphosphonate: was prepared as described above Diethylphosphinic acid aluminum salt (DEPAL): EXOLIT OP 930, Clariant, Switzerland Melamine polyphosphate (MPP): Melapur® 200, Ciba, Switzerland

1. A process for the preparation of a condensation product of melamine and phenylphosphonic acid comprising
a) neutralizing or mixing a phenylphosphonic acid of formula (I) 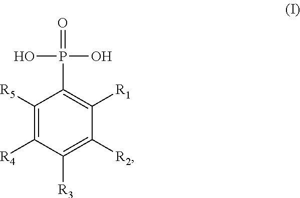
with melamine at a temperature from 20° C. to 100° C. wherein the molar ratio of melamine to the phenylphosphonic acid of formula (I) is equal to or greater than 1;
R₁-R₅ independently of one another represent hydrogen or a substituent selected from the group consisting of C₁-C₄alkyl, hydroxy, hydroxy-C₁-C₄alkyl and C₁-C₄alkoxy; and
b) reacting the mixture at a temperature between 150° C. to 400° C. to form the condensation product of melamine and the phenylphosphonic acid of formula (I),
wherein the melam content is at least 0.1 mol per mole of condensation product.

2. A process according to claim 1 wherein R₁-R₅ are each hydrogen.

3. A condensation product obtained according to claim 1.

4. A condensation product of melamine and phenylphosphonic acid of formula (II) 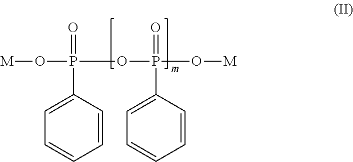
wherein
M is a protonated form of melamine or of a melamine condensate; and
m is a number between 0 and 50, indicating the average degree of condensation of the phenylphosphonate residue; and
where the melam content is at least 0.1 mol per mole of condensation product.

5. A condensation product according to claim 4 which exhibits a pH value of 5 or higher as measured in a 10% by weight slurry in water.

6. A condensation product according to claim 4 comprising as a melamine condensate 10%-100% by weight of melam, based on the weight of the melamine plus the weight of the melamine condensates.

7. A condensation product according to claim 4 comprising as a melamine condensate 10%-100% by weight of melam, based on the weight of the melamine plus the weight of the melamine condensates and where m is from 0 to 30.

8. A flame retarding composition comprising
a) a condensation product according to claim 4 and
b) a polymer substrate.

9. A process for imparting flame retardancy to a polymer substrate, which process comprises adding to a polymer substrate a condensation product according to claim 4.

10. A process according to claim 9 comprising adding a further additive selected from the group consisting of anti-dripping agents, polymer stabilizers and additional flame retardants.

11. A composition according to claim 8 comprising b) a polyester, polyamide, polysulfone or a polycarbonate substrate.

12. A composition according to claim 8, comprising b) a polyfunctional epoxide compound and a hardener compound.

13. A condensation product according to claim 6 where m is between 0.2 and 2.5.

14. A condensation product of melamine and phenylphosphonic acid of formula (IIa) 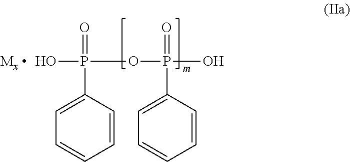
wherein
M is melamine or a melamine condensate,
m is a number between 0 and 50; and
x is from 1 to 2; and
where the melam content is at least 0.1 mol per mole of condensation product.

15. A product according to claim 14 of formula (III)

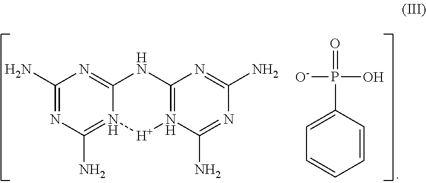

16. A condensation product according to claim 14 which exhibits a pH value of 5 or higher as measured in a 10% by weight slurry in water.

17. A condensation product according to claim 14 comprising as a melamine condensate 10%-100% by weight of melam, based on the weight of the melamine plus the weight of the melamine condensates and where m is from 0 to 30.

18. A condensation product according to claim 17 where m is between 0.2 and 2.5.

19. A flame retarding composition comprising
a) a condensation product according to claim 14 and
b) a polymer substrate.

20. A composition according to claim 19 comprising b) a polyester, polyamide, polysulfone or a polycarbonate substrate.

21. A composition according to claim 19 comprising b) a polyfunctional epoxide compound and a hardener compound.
